(19) United States
(12) Patent Application Publication
(10) Pub. No.: US 2006/0126640 A1
(43) Pub. Date: Jun. 15, 2006

(54) High performance Transmission Control Protocol (TCP) SYN queue implementation

(76) Inventors: Sanjeev H. Sood, San Diego, CA (US); Yunhong Li, San Diego, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/013,061

(22) Filed: Dec. 14, 2004

(51) Int. Cl. H04L 12/56; H04L 12/28

(52) U.S. Cl. 370/395.32

(57) ABSTRACT

In general, in one aspect, the disclosure describes a method that includes accessing a first Internet Protocol datagram comprising a first Transmission Control Protocol segment representing a connection open request, determining a first hash result based, at least in part, on the Internet Protocol source and destination addresses of the Internet Protocol datagram, and the source and destination port numbers of the first Transmission Control Protocol segment. The method also includes accessing a first bucket of array elements from a first array based on at least a portion of the determined hash result where different array elements correspond to different respective open requests. The method also includes storing an entry for the open request in an array element of the bucket.

### BACKGROUND

Networks enable computers and other devices to communicate. For example, networks can carry data representing video, audio, e-mail, and so forth. Typically, data sent across a network is carried by smaller messages known as packets. By analogy, a packet is much like an envelope you drop in a mailbox. A packet typically includes payload and a header. The packet's payload is analogous to the letter inside the envelope. The packet's header is much like the information written on the envelope itself. The header can include information to help network devices handle the packet appropriately.

A number of network protocols (e.g., “a protocol stack”) cooperate to handle the complexity of network communication. For example, a transport protocol known as Transmission Control Protocol (TCP) provides applications with simple mechanisms for establishing a connection and transferring data across a network. Transparent to these applications, TCP handles a variety of communication issues such as data retransmission, adapting to network traffic congestion, and so forth.

To provide these services, TCP operates on packets known as segments. Generally, a TCP segment travels across a network within (“encapsulated” by) a larger packet such as an Internet Protocol (IP) datagram. Frequently, an IP datagram is further encapsulated by an even larger packet such as an Ethernet frame. The payload of a TCP segment carries a portion of a stream of data sent across a network by an application. A receiver can restore the original stream of data by reassembling the received segments. To permit reassembly and acknowledgment (ACK) of received data back to the sender, TCP associates a sequence number with each byte transmitted.

In TCP, a connection between end-points is established using a “three-way handshake”. Initially, a client sends an open request (i.e., a segment with the SYN flag set in the TCP header). In response, the server replies with a SYN/ACK segment acknowledging the client's open request. Finally, the client acknowledges the server's response.

### BRIEF DESCRIPTION OF THE DRAWINGS

FIG. 1 illustrates a SYN queue implemented using static arrays.

FIG. 2 illustrates a process to perform a lookup in the SYN queue.

FIG. 3 illustrates a process to time-out open requests.

FIG. 4 illustrates an example of a multi-core processor

FIG. 5 illustrates a network device.

### DETAILED DESCRIPTION

As described above, establishing a connection using TCP's three-way handshake creates a period of time between a server's receipt of the original open request and receipt of the final ACK completing connection establishment. To keep track of these pending open requests, TCP implementations often feature a SYN queue (SYNQ) that stores minimal state data for a requested connection until connection establishment completes and a full connection context (e.g., a TCB (Transmission Control Block)) is created for the connection. The SYNQ continually changes as new open requests arrive and connections for previous open requests complete. Additionally, many systems implement a time-out scheme that purges open requests from the SYNQ that do not complete the handshake after some period of time.

High performance TCP system supports a large volume of connection setups and tear-downs (e.g., currently hundred of thousands connections per second). A hurdle in achieving this high rate is the memory latency associated with SYNQ lookups. For example, receipt of an ACK from a client results in a search of the SYNQ in an attempt to match the ACK with a previously received open request.

In the past, SYNQs have been implemented using linked lists or hash tables with a link list associated with each hash bucket. In such implementations, searching the SYNQ can be performed by traversing a linked list, node by node until either a matching SYNQ entry is found or the end of the list is reached. Traversing the linked list may require many memory accesses and is especially burdensome when no match exists. Further, due to a large volume of connection open requests, the linked lists may grow quite long and become difficult to quickly traverse.

This disclosure describes techniques that implement a SYNQ without necessitating the use of linked lists to store and access SYNQ information. Instead, the SYNQ can be implemented using one or more arrays. Potentially, these arrays may be static (i.e., of a fixed preallocated size). As described below, the use of arrays can drastically reduce the number of memory accesses needed to store and retrieve SYNQ entries. These techniques may also ease the task of timing out stale open requests.

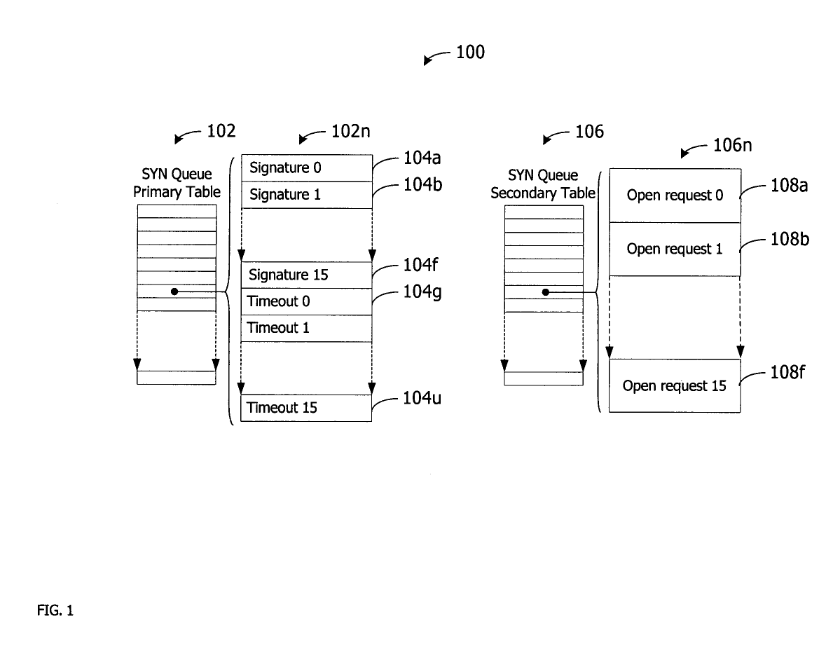

To illustrate, FIG. 1 depicts a sample implementation of a SYNQ 100 using a pair of static arrays labeled the “primary” table 102 and the “secondary” table 106. The primary table 102 stores signatures (bit sequences) identifying different TCP/IP connections having pending open requests. The secondary table 106 stores the actual SYNQ state data for each pending open request (e.g., an Internet source address of an open request, the Internet destination address of the open request, TCP options specified by the open request, and so forth).

As shown, each array 102, 106 is segmented into a collection of buckets where a given bucket includes some fixed number of entries. For example, each bucket 102n in the primary table includes 16-slots 104a-104f for flow signatures while each bucket 106n of the secondary table 106 in FIG. 1 includes 16-slots for open requests 108a-108f. As shown, there may be a one-to-one relationship between primary and secondary table buckets and entries. That is, the bucket index and slot index associated with a particular open request is the same in both primary 102 and secondary 106 tables (e.g., the state data for an open request having signature 104b is stored in open request data 108b). A packet may be mapped to a given bucket, for example, based on a hash operation on information (a “tuple”) in the packet's header(s) (e.g., the packet's IP source and destination addresses, and source and destination ports). The first m-bits of the hash result may provide a bucket index while the remaining bits form the connection signature.

When an open request is received, the request is mapped to a primary table 102 bucket 102x and the signature of the request is searched for within the bucket to ensure that an open request is not already pending for this flow. If no matching signatures were found in the primary table bucket 102x (or matching signatures in the primary table 102 do not correspond to matching open requests in the secondary table 106), the open request represents a new request and an available array element is allocated for the request and state data for the request is stored in a corresponding slot within bucket 106x. If the primary table bucket 102x is full, the SYN packet may be silently dropped with the expectation that the client will retransmit the SYN again when a bucket slot may be available due to entries being removed from the SYNQ.

When an ACK is received, the SYNQ logic attempts to match the ACK to a pending open request. Thus, the logic determines a bucket 102x for the ACK segment and searches the bucket 102x for signatures matching that of the ACK segment. If a match is found, the ACK may represent the last phase of the three-way handshake and the corresponding state data 108x for the open request is accessed. Since the signatures of different flow open requests may, potentially, be the same (a “collision”), the tuples of the open request and ACK packet are compared to ensure a correct match. If the tuples match, the open request data is used to complete connection establishment and the open request entry is deallocated from the SYNQ. Otherwise the search of the primary table bucket 102x continues.

Collecting multiple signatures/open requests into a single bucket can reduce the latency associated with accessing a SYNQ. For example, instead of multiple accesses used to navigate a linked list, each bucket may be read in a single read operation. In other words, at the cost of a single read operation, the data for N-flows can be quickly accessed instead of a read operation for each one. Additionally, splitting the lookup and SYNQ state data into different arrays can speed lookup operations. For example, the primary table 102 can be stored in faster memory (e.g., SRAM) than the secondary 106 table (e.g., DRAM). Thus, an implementation can quickly determine if a potential match exists before accessing slower memory to access the actual open request.

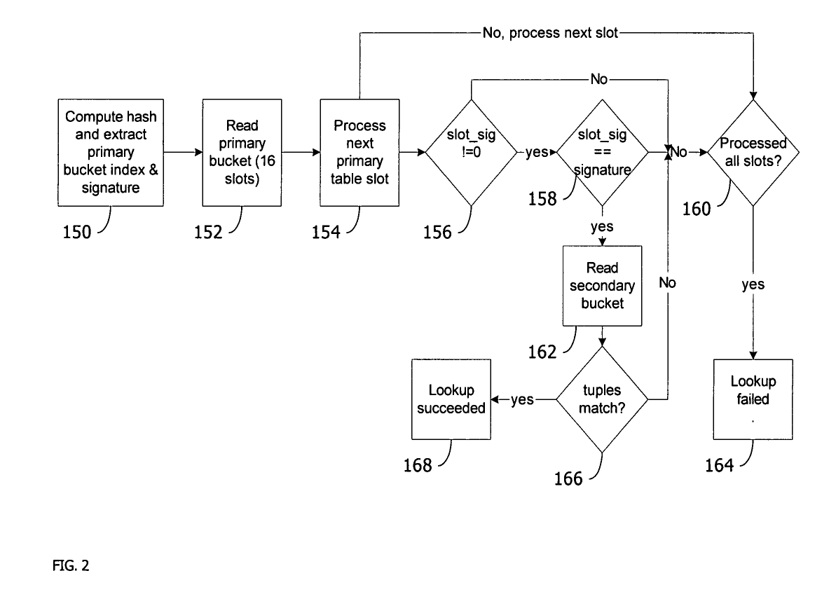

FIG. 2 illustrates a sample process to perform a SYNQ lookup to match an ACK packet with a pending open request using the arrays 102, 106 shown in FIG. 1. As shown, a hash operation 150 is performed on the ACK packet's tuple yielding a hash result. The primary bucket index and signature are derived from the hash result. After reading 152 the primary bucket 154 identified by the primary bucket index, a match for the packet's signature is searched for 156, 158, in the primary bucket slots. If a match is found, the corresponding secondary table bucket is read 162. If the tuple of the corresponding open request in the secondary table bucket matches 166 the tuple of the ACK packet, the lookup succeeds 168. Otherwise, the search for a matching signature in the primary bucket can continue. If all slots 160 of the primary bucket have been examined and no matching open request has been found, the lookup has failed 164.

As shown in FIG. 1, in addition to a signature 104a-104f, a bucket 102x can include data that identifies a timeout value for each pending open request. For example, as shown, primary table bucket 102n stores timeout values 104g-104u for open requests associated with array elements 104a-104f. The timeout values are grouped in an array such that the timeout for a given open request has the same offset from the start of the series of timeout values 104g-104u as the corresponding open request signature from the start of the series of signature values 104a-104f. Grouping multiple timeout values together in a bucket 102n enables the values to be read in a single operation and permits quick examination of timeout values of many different pending open requests.

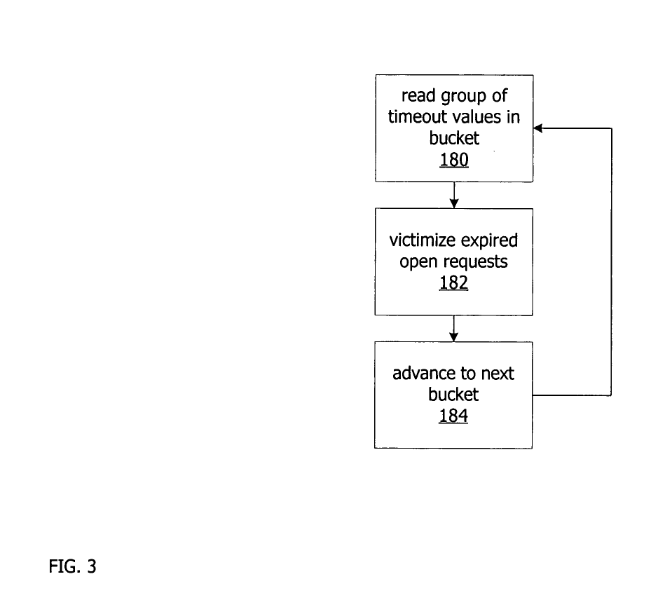

FIG. 3 illustrates a sample process to time-out stale open requests. As shown, the process can read 160 a group of timeout values in a given bucket, compare 162 each value to a clock value, and clear the bucket of signatures for open requests that have expired. The process can continually operate, circling 164 around the array 102 bucket by bucket, victimizing stale open requests as it goes. For example, the timeout process may perform a block read of a bucket each time period.

While FIGS. 1-3 depict a sample implementation, other implementations may vary. For example, FIG. 1 depicted parallel static arrays 102, 106. However, instead of a pair of parallel arrays, a single monolithic array may be used that stores all the data associated with a pending open request. Additionally, while FIG. 1 depicted the time-out values and signature values as being stored non-contiguously, these values may be interspersed in alternating array elements. Again, these are merely examples and a wide variety of other variations are possible.

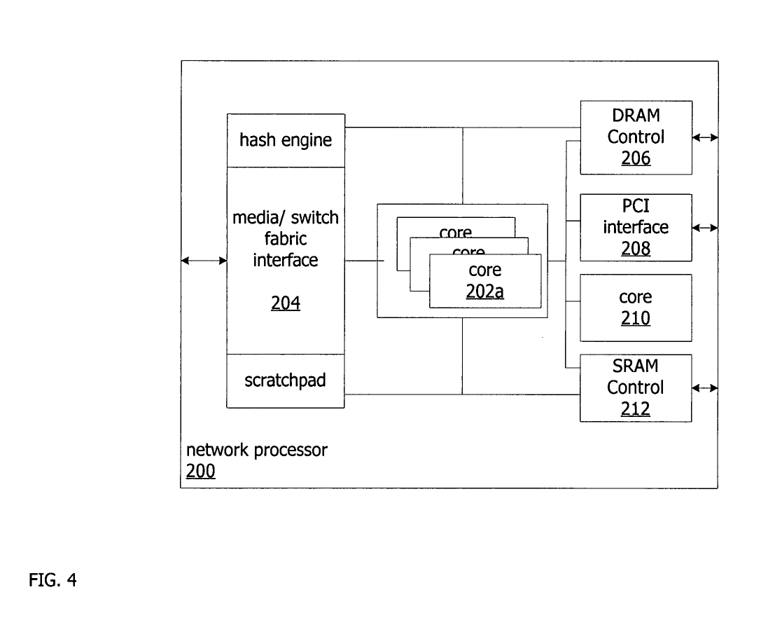

The techniques described above may be implemented on a wide variety of devices. For instance, FIG. 4 depicts an example of network processor 200. The network processor 200 shown is an Intel® Internet eXchange network Processor (IXP). Other network processors feature different designs.

The network processor 200 shown features a collection of programmable processing cores 202 on a single integrated semiconductor die. Each core 202 may be a Reduced Instruction Set Computing (RISC) processor tailored for packet processing. For example, the cores 202 may not provide floating point or integer division instructions commonly provided by the instruction sets of general purpose processors. Individual cores 202 may provide multiple threads of execution. For example, a core 202 may store multiple program counters and other context data for different threads.

The network processor 200 also includes an additional core processor 210 (e.g., a StrongARM® XScale® or Intel® Architecture (IA) core) that is often programmed to perform “control plane” tasks involved in network operations. This core processor 210, however, may also handle “data plane” tasks.

As shown, the network processor 200 also features at least one interface 202 that can carry packets between the processor 200 and other network components. For example, the processor 200 can feature a switch fabric interface 202 (e.g., a Common Switch Interface (CSIX)) that enables the processor 200 to transmit a packet to other processor(s) or circuitry connected to the fabric. The processor 200 can also feature an interface 202 (e.g., a System Packet Interface (SPI) interface) that enables the processor 200 to communicate with physical layer (PHY) and/or link layer devices (e.g., MAC or framer devices). The processor 200 also includes an interface 208 (e.g., a Peripheral Component Interconnect (PCI) bus interface) for communicating, for example, with a host or other network processors.

As shown, the processor 200 also includes other components shared by the cores 202 such as a hash core, internal scratchpad memory shared by the cores, and memory controllers 206, 212 that provide access to external memory shared by the cores. The SYNQ arrays may be stored in different memories. For example, the primary table may be stored in Static Random Access Memory (SRAM) while the secondary array is stored in slower Dynamic Random Access Memory (DRAM). This can speed lookups since signature comparisons are performed using data stored in faster SRAM.

The cores 202 may communicate with other cores 202 via the core 210 or other shared resources. The cores 202 may also intercommunicate via neighbor registers directly wired to adjacent core(s) 204. Individual cores 202 may feature a Content Addressable Memory (CAM). Alternately, a CAM may be a resource shared by the different cores 202.

The techniques described above may be implemented by software executed by one or more of the cores 202. For example, the cores 202 may be programmed to implement a packet processing pipeline where threads operating on one or more core threads perform Ethernet operations (e.g., Ethernet receive, Ethernet de-encapsulation), IPv4 and/or IPv6 operations (e.g., verification), and threads on one or more cores handle TCP operation such as the SYNQ operations described above. Other threads may implement application operations on the resulting data stream.

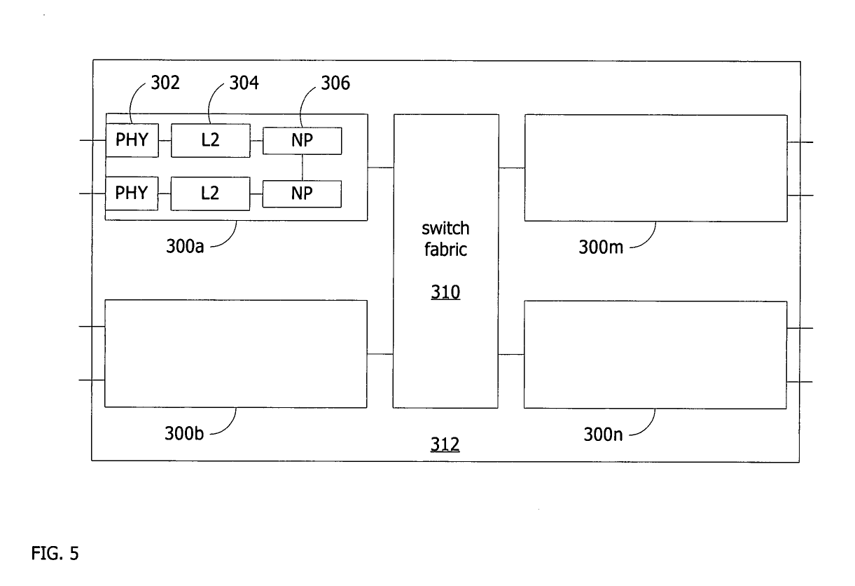

FIG. 5 depicts a network device that can process packets using techniques described above. As shown, the device features a collection of line cards 300 (“blades”) interconnected by a switch fabric 310 (e.g., a crossbar or shared memory switch fabric). The switch fabric, for example, may conform to CSIX or other fabric technologies such as HyperTransport, Infiniband, PCI, Packet-Over-SONET, RapidIO, and/or UTOPIA (Universal Test and Operations PHY Interface for ATM).

Individual line cards (e.g., 300a) may include one or more physical layer (PHY) devices 302 (e.g., optic, wire, and wireless PHYs) that handle communication over network connections. The PHYs translate between the physical signals carried by different network mediums and the bits (e.g., “0”-s and “1”-s) used by digital systems. The line cards 300 may also include framer devices (e.g., Ethernet, Synchronous Optic Network (SONET), High-Level Data Link (HDLC) framers or other “layer 2” devices) 304 that can perform operations on frames such as error detection and/or correction. The line cards 300 shown may also include one or more network processors 306 that perform packet processing operations for packets received via the PHY(s) 302 and direct the packets, via the switch fabric 310, to a line card providing an egress interface to forward the packet. Potentially, the network processor(s) 306 may perform “layer 2” duties instead of the framer devices 304.

While FIGS. 4 and 5 described specific examples of a network processor and a device incorporating network processors, the techniques may be implemented in a variety of architectures including processors and devices having designs other than those shown. For example, the techniques may be used in a TCP Offload Engine (TOE). Such a TOE may be integrated into a IP storage node, application (“layer 7”) load balancer, or other devices.

Additionally, the techniques described above may be used to handle other transport layer protocol, protocols in other layers within a network protocol stack, protocols other than TCP and IP, and to handle other protocol data units. For example, the techniques may be used to handle other connection oriented protocols such as Asynchronous Transfer Mode (ATM) packets (“cells”) or User Datagram Protocol (UDP). As used above, the term IP encompasses both IPv4 and IPv6 IP implementations.

The term circuitry as used herein includes hardwired circuitry, digital circuitry, analog circuitry, programmable circuitry, and so forth. The programmable circuitry may operate on executable instructions disposed on an article of manufacture (e.g., a non-volatile memory such as a Read Only Memory).

Other embodiments are within the scope of the following claims.

What is claimed is:

1. A method, comprising:
accessing a first Internet Protocol datagram comprising a first Transmission Control Protocol segment representing a connection open request;
determining a first hash result based, at least in part, on the Internet Protocol source and destination addresses of the Internet Protocol datagram, and the source and destination port numbers of the first Transmission Control Protocol segment;
accessing a first bucket of array elements from a first array based on at least a portion of the determined hash result, wherein different array elements of the first bucket correspond to different respective open requests; and
storing an entry for the open request in an array element of the bucket.

2. The method of claim 1,
further comprising accessing a second Internet Protocol datagram comprising a second Transmission Control Protocol segment having an ACK flag set;
determining a second hash result based, at least in part, on the Internet Protocol source and destination addresses of the second Internet Protocol datagram, and the source and destination port numbers of the second Transmission Control Protocol segment;
accessing a bucket of array elements from the first array based on at least a portion of the determined hash result; and
determining if at least one array element of the bucket corresponds to a pending open request of the second Transmission Control Protocol segment.

3. The method of claim 1,
further comprising deallocating at least one array element associated with the pending open request based on a determining at least one array element of the bucket corresponds to a pending open request of the second Transmission Control Protocol segment.

4. The method of claim 1, wherein the storing comprises storing at least a portion of the first hash result.

5. The method of claim 1, wherein the bucket stores timeout values for the different respective open requests.

6. The method of claim 7, further comprising clearing one or more entries of a bucket based on the timeout values.

7. The method of claim 1, further comprising:
writing an entry in a corresponding bucket of a second array.

8. The method of claim 7, wherein the entry comprises at least one of an Internet source address of the packet, the Internet destination address of the packet, and at least one Transmission Control Protocol option.

9. The method of claim 7, wherein the first array comprises an array stored in SRAM and the second array comprises an array stored in DRAM.

10. The method of claim 1, wherein the determining comprises executing instructions at one of a set of multiple processor cores disposed on a single integrated die.

11. The method of claim 1, wherein the bucket comprises data less than the maximum number of bytes accessible by a single read instruction.

12. An article of manufacture comprising instructions for causing at least one processor to:
access a first Internet Protocol datagram comprising a first Transmission Control Protocol segment representing a connection open request;
determine a first hash result based, at least in part, on the Internet Protocol source and destination addresses of the Internet Protocol datagram, and the source and destination port numbers of the first Transmission Control Protocol segment;
access a first bucket of array elements from a first array based on at least a portion of the determined hash result, wherein different array elements of the first bucket correspond to different respective open requests; and
store an entry for the open request in an array element of the bucket.
access a second Internet Protocol datagram comprising a second Transmission Control Protocol segment having an ACK flag set;
determine a second hash result based, at least in part, on the Internet Protocol source and destination addresses of the second Internet Protocol datagram, and the source and destination port numbers of the second Transmission Control Protocol segment;
access a bucket of array elements from the first array based on at least a portion of the determined hash result; and
determine if at least one array element of the bucket corresponds to a pending open request of the second Transmission Control Protocol segment.

13. The article of claim 12,
further comprising instructions to deallocate at least one array element associated with the pending open request based on a determining at least one array element of the bucket corresponds to a pending open request of the second Transmission Control Protocol segment.

14. The article of claim 12, wherein the instructions to store comprise instructions to store at least a portion of the first hash result.

15. The article of claim 12, wherein the bucket stores timeout values for the different respective open requests.

16. The article of claim 15, further comprising instructions to clear one or more entries of a bucket based on the timeout values.

17. The article of claim 12, further comprising:
writing an entry in a corresponding bucket of a second array.

18. The article of claim 17, wherein the entry comprises at least one of an Internet source address of the packet, the Internet destination address of the packet, and at least one Transmission Control Protocol option.

19. The article of claim 17, wherein the first array comprises an array stored in SRAM and the second array comprises an array stored in DRAM.

20. The article of claim 12, wherein the bucket comprises data less than the maximum number of bytes accessible by a single read instruction.

21. A system, comprising:
multiple cores integrated on a single integrated die; and
logic to:
access a first Internet Protocol datagram comprising a first Transmission Control Protocol segment representing a connection open request;
determine a first hash result based, at least in part, on the Internet Protocol source and destination addresses of the Internet Protocol datagram, and the source and destination port numbers of the first Transmission Control Protocol segment;
access a first bucket of array elements from a first array based on at least a portion of the determined hash result, wherein different array elements of the first bucket correspond to different respective open requests; and
store an entry for the open request in an array element of the bucket.
access a second Internet Protocol datagram comprising a second Transmission Control Protocol segment having an ACK flag set;
determine a second hash result based, at least in part, on the Internet Protocol source and destination addresses of the second Internet Protocol datagram, and the source and destination port numbers of the second Transmission Control Protocol segment;
access a bucket of array elements from the first array based on at least a portion of the determined hash result; and
determine if at least one array element of the bucket corresponds to a pending open request of the second Transmission Control Protocol segment.

22. The system of claim 21,
further comprising logic to deallocate at least one array element associated with the pending open request based on a determining at least one array element of the bucket corresponds to a pending open request of the second Transmission Control Protocol segment.

23. The system of claim 21, wherein the bucket stores timeout values for the different respective open requests.

24. The system of claim 21, wherein the first array comprises an array stored in SRAM and the second array comprises an array stored in DRAM.

25. The system of claim 21, wherein the bucket comprises data less than the maximum number of bytes accessible by a single read instruction.

26. An article of manufacture comprising instructions for causing at least one processor to:
access a first array of buckets, individual buckets in the first array of buckets storing an array of identifiers of Transmission Control Protocol (TCP) open requests; and
access a second array of buckets, individual buckets in the second array of buckets storing an array of state data for the TCP open requests.

27. The article of claim 26, wherein the buckets in the first array of buckets and the second array of buckets have a one to one relationship.

28. The article of claim 26, wherein the first array of buckets is stored in a different memory than the second array of buckets.

29. The article of claim 26,
wherein the identifier comprises a portion of a hash result obtained by a hash operation on an Internet Protocol (IP) datagram encapsulating the TCP open request; and
wherein an index of a bucket associated with the TCP open request is identified by a portion of the same hash result.

30. The article of claim 26,
further comprising instructions to access the first bucket and the second bucket to match a TCP ACK with a previously received TCP open request.
